(19) United States
(12) Patent Application Publication
(10) Pub. No.: US 2018/0287187 A1
(43) Pub. Date: Oct. 4, 2018

(54) THREE-DIMENSIONAL THIN-FILM BATTERY DEVICE

(71) Applicant: International Business Machines Corporation, Armonk, NY (US)

(72) Inventors: Yun Seog Lee, White Plains, NY (US); Jae-Woong Nah, Closter, NJ (US); Dahyun Oh, San Jose, CA (US); Devendra K. Sadana, Pleasantville, NY (US)

(21) Appl. No.: 15/815,842

(22) Filed: Nov. 17, 2017

Related U.S. Application Data
(63) Continuation of application No. 15/474,434, filed on Mar. 30, 2017.

(51) Int. Cl. H01M 10/04; H01M 10/0562; H01M 4/525; H01M 4/38; H01M 10/0525

(52) U.S. Cl. CPC H01M 10/0436; H01M 2220/30; H01M 2300/0068; H01M 10/0562; H01M 10/0525; H01M 4/525; H01M 4/382

(57) ABSTRACT

A three-dimensional (3D) thin-film battery device that has improved capacity and reduced specific resistance, without increased lateral battery size, is provided. The 3D thin-film battery device includes an all solid-state battery stack structure (e.g., a lithium-based battery stack structure) that is present on a surface of a textured substrate. The textured substrate is formed utilizing a photolithography-free patterning process in which a plurality of metallic islands is first formed on a surface of a non-textured substrate by deposition and annealing. An etch is then employed to intentionally texture a non-textured substrate utilizing each metallic island as an etch mask.

### BACKGROUND

The present application relates to a thin-film battery device and a method of forming the same. More particularly, the present application relates to a three-dimensional (3D) thin-film battery device having improved capacity and reduced area specific resistance, without increased lateral device size as well as a method of forming such a thin-film battery device.

In recent years, there has been an increased demand for portable electronic devices such as, for example, computers, mobile phones, tracking systems, scanners, medical devices, smart watches, and fitness devices. One drawback with portable electronic devices is the need to include a power supply within the device itself. Typically, a battery is used as the power supply of such portable electronic devices. Batteries must have sufficient capacity to power the portable electronic device for at least the length that the device is being used. Sufficient battery capacity can result in a power supply that is quite heavy and/or large compared to the rest of the portable electronic device. As such, smaller sized and lighter weight power supplies with sufficient energy storage are desired. Such power supplies can be implemented in smaller and lighter weight portable electronic devices.

Another drawback of conventional batteries is that some of the batteries contain potentially flammable and toxic materials that may leak and may be subject to governmental regulations. As such, it is desired to provide an electrical power supply that is safe, solid-state and rechargeable over many charge/discharge life cycles.

One type of an energy-storage device that is small and light weight, contains non-toxic materials and that can be recharged over many charge/discharge cycles is a solid-state, lithium-based thin-film battery. Lithium-based thin-film batteries are storage batteries that include two electrodes implementing lithium. One drawback with lithium-based thin-film batteries is that small form factors limit the capacity of the battery. Moreover, such lithium-based thin-film batteries contain a solid-state electrolyte that has low ionic conductivity and therefore high internal resistance. There is thus a need for providing three-dimensional (3D) thin-film batteries, particularly lithium-based thin-film batteries, which have improved capacity and reduced specific resistance, without increased lateral battery size.

### SUMMARY

A three-dimensional (3D) thin-film battery device that has improved capacity and reduced specific resistance, without increased lateral battery size, is provided. The term “thin-film battery” is used throughout the present application to denote a battery whose thickness is 100 μm or less. Such thin-film batteries are small and light weight, and thus can be implemented in many different types of portable electronic devices. The 3D thin-film battery device of the present application includes an all solid-state battery stack structure (e.g., a lithium-based battery stack structure) that is present on a surface of an intentionally textured substrate. The term “all solid-state” denotes a battery stack structure in which all the battery components, including the electrolyte, are solid materials. The intentionally textured substrate is formed utilizing a photolithography-free patterning process in which a plurality of metallic islands is first formed on a surface of a non-textured substrate by deposition and annealing. An etch is then employed to provide a textured substrate utilizing each metallic island as an etch mask.

In one aspect of the present application, a three-dimensional (3D) thin-film battery device is provided. In one embodiment, the 3D thin-film battery device includes a substrate having a textured surface. An all solid-state battery stack structure is located on the textured surface of the substrate. In one embodiment, the all solid-state battery stack structure is a lithium-based battery stack structure.

In another aspect of the present application, a method of forming a three-dimensional (3D) thin-film battery device is provided. In one embodiment, the method includes forming a continuous metallic layer on a surface of a substrate. The continuous metallic layer is then annealed to convert the continuous metallic layer into a plurality of metallic islands. Next, the substrate is etched utilizing each metallic island as an etch mask to provide the substrate with a textured surface. After etching, each metallic island is removed, and thereafter an all solid-state battery stack structure is formed on the textured surface of the substrate. In one embodiment, the all solid-state battery stack structure is a lithium-based battery stack structure.

### BRIEF DESCRIPTION OF SEVERAL VIEWS OF THE DRAWINGS

FIG. 1 is a cross sectional view of an exemplary structure including a continuous metallic layer present on a non-textured surface of a substrate that can be employed in one embodiment of the present application.

FIG. 2 is a cross sectional view of the exemplary semiconductor structure of FIG. 1 after performing an anneal to convert the continuous metallic layer into metallic islands.

FIG. 3 is a cross sectional view of the exemplary semiconductor structure of FIG. 2 after etching the substrate utilizing each metallic island as an etch mask to provide a textured substrate.

FIG. 4 is a cross sectional view of the exemplary semiconductor structure of FIG. 3 after removing each metallic island.

FIG. 5 is a cross sectional view of the exemplary semiconductor structure of FIG. 4 after forming an all solid-state battery stack structure on the textured substrate.

FIG. 6 is a cross sectional view of an exemplary lithium-based battery stack structure that can be employed as the all solid-state battery stack structure of FIG. 5.

### DETAILED DESCRIPTION

The present application, which provides a thin-film battery device and a method of forming the same, will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

A three-dimensional (3D) thin-film battery device that has improved capacity and reduced specific resistance, without increased lateral battery size, is provided utilizing a fabrication process (i.e., method) that is compatible with CMOS processing and/or monolithic integration to other microelectronic devices. The method of the present application, which will be defined in greater detail herein below, includes providing a substrate having a textured surface, and thereafter forming an all solid-state battery stack structure on the textured surface of the substrate. In one embodiment, the all solid-state battery stack structure is a lithium-based battery stack structure.

The textured surface is formed utilizing a photolithography-free patterning process in which a plurality of metallic islands is first formed on a non-textured surface of the substrate by deposition of a continuous metallic layer and annealing. The pattern geometry (i.e., pitch and density) of each metallic island can be controlled by the thickness of the deposited metallic layer and the annealing conditions employed. An etch is then employed to intentionally texture the substrate utilizing each metallic island as an etch mask.

The substrate containing the textured surface can used to provide a 3D thin-film battery device that has increased interfacial area between a solid-state electrolyte and the electrode material, which may in turn, facilitate metal ion, e.g., lithium ion, transfer to the electrode material. Moreover and in some embodiments, the substrate containing the textured surface may be used to provide a 3D thin-film battery device that has decreased metal ion, e.g., lithium ion, diffusion and electron path length with a cathode as compared to a 3D thin-film battery device that contains a non-textured (i.e., planar) substrate. Furthermore, the substrate containing the textured surface may be used to provide a 3D thin-film battery device that exhibits improved adhesion.

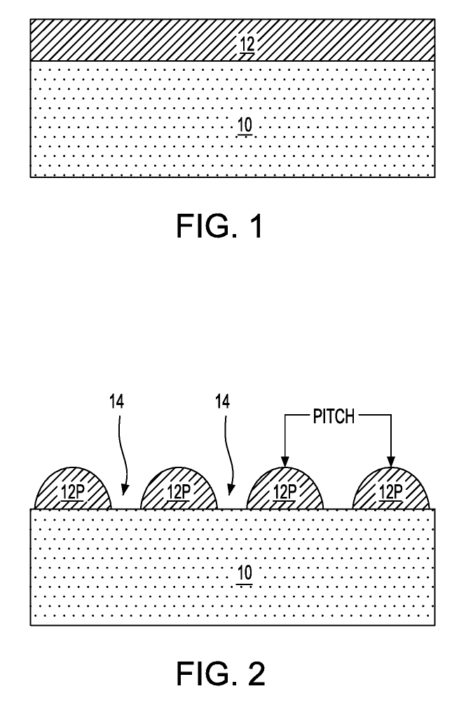

Referring first to FIG. 1, there is illustrated an exemplary structure that can be employed in one embodiment of the present application. The exemplary structure illustrated in FIG. 1 includes a continuous metallic layer 12 present on a non-textured (i.e., planar or flat) surface of a substrate 10; substrate 10 may also be referred to as non-textured substrate 10. The term “non-textured surface” denotes a surface that is smooth and has a surface roughness on the order of less than 100 nm root mean square as measured by profilometry. The term “non-textured substrate” denotes a substrate having a surface roughness on the order of less than 100 nm root mean square as measured by profilometry. At this point of the present application, the non-textured substrate 10 is not subjected to any process in which surface roughness (i.e., texture) is intentionally introduced into the substrate 10.

The substrate 10 that can be employed in the present application includes any conventional material that is used as a substrate for a thin-film battery. In one embodiment, the substrate 10 may include one or more semiconductor materials. The term “semiconductor material” is used throughout the present application to denote a material having semiconducting properties.

Examples of semiconductor materials that may be employed as substrate 10 include silicon (Si), germanium (Ge), silicon germanium alloys (SiGe), silicon carbide (SiC), silicon germanium carbide (SiGeC), III-V compound semiconductors or II-VI compound semiconductors. III-V compound semiconductors are materials that include at least one element from Group III of the Periodic Table of Elements and at least one element from Group V of the Periodic Table of Elements. II-VI compound semiconductors are materials that include at least one element from Group II of the Periodic Table of Elements and at least one element from Group VI of the Periodic Table of Elements.

In one embodiment, the semiconductor material that may provide substrate 10 is a bulk semiconductor substrate. By “bulk” it is meant that the substrate 10 is entirely composed of at least one semiconductor material, as defined above. In one example, the substrate 10 may be entirely composed of silicon. In some embodiments, the bulk semiconductor substrate may include a multilayered semiconductor material stack including at least two different semiconductor materials, as defined above. In one example, the multilayered semiconductor material stack may comprise, in any order, a stack of Si and a silicon germanium alloy.

In another embodiment, substrate 10 is composed of a topmost semiconductor material layer of a semiconductor-on-insulator (SOI) substrate. The SOI substrate would also include a handle substrate (not shown) including one of the above mentioned semiconductor materials, and an insulator layer (not shown) such as a buried oxide below the topmost semiconductor material layer.

In any of the embodiments mentioned above, the semiconductor material that may provide the substrate 10 may be a single crystalline semiconductor material. The semiconductor material that may provide the substrate 10 may have any of the well known crystal orientations. For example, the crystal orientation of the semiconductor material that may provide substrate 10 may be {100}, {110}, or {111}. Other crystallographic orientations besides those specifically mentioned can also be used in the present application.

In another embodiment, the substrate 10 is a metallic material that can be textured as described herein below and that has a higher melting temperature than the annealing temperature used in the present application to provide the metallic islands. Examples of metallic materials that can be used as the substrate 10 include, but are not limited to, aluminum (Al), an aluminum alloy, titanium (Ti), tantalum (Ta), tungsten (W), or molybdenum (Mo).

In a further embodiment, the substrate 10 is a dielectric material such as, for example, doped or non-doped silicate glass, silicon dioxide, or silicon nitride. In yet a further embodiment, the substrate 10 is composed of a polymer or flexible substrate material such as, for example, a polyimide, a polyether ketone (PEEK) or a transparent conductive polyester.

In yet an even further embodiment, the substrate 10 may be composed of a multilayered stack of at least two of the above mentioned substrate materials, e.g., a stack of silicon and silicon dioxide.

The substrate 10 that can be used in the present application can have a thickness from 10 μm to 5 mm. Other thicknesses that are lesser than, or greater than, the aforementioned thickness values may also be used for substrate 10.

The continuous metallic layer 12 is then formed over the entirety of a physically exposed surface of substrate 10 in which texturing is to be subsequently performed. The term “continuous” denotes that there are no breaks or gaps in the metallic layer 12 that physically expose the surface of the substrate 10. The continuous metallic layer 12 includes any metal or metal alloy that has a melting point of less than 700° C. The metal or metal alloy that is selected must be capable of being melted and balled-up during a subsequently performed anneal such that de-wetting of the surface of substrate 10 occurs. In one embodiment, the continuous metallic layer 12 is composed of tin, indium, gallium or alloys thereof. Typically, the continuous metallic layer 12 is composed of unalloyed tin.

The continuous metallic layer 12 may be formed utilizing a deposition process. Deposition processes that can be used to provide the continuous metallic layer 12 include, but are not limited to, chemical vapor deposition (CVD), plasma enhanced chemical vapor deposition (PECVD), atomic layer deposition (ALD), physical vapor deposition (PVD), sputtering or plating. The continuous metallic layer 12 may have a thickness from 10 nm to 500 nm. Other thicknesses that are lesser than, or greater than, the aforementioned thickness values may also be used for continuous metallic layer 12.

Referring now to FIG. 2, there is illustrated the exemplary semiconductor structure of FIG. 1 after performing an anneal. The anneal converts the continuous metallic layer 12 into metallic islands 12P. An opening 14 is formed between each metallic island 12P that physically exposes a portion of the surface of non-textured substrate 10. Thus, during the anneal, the continuous metallic layer 12 melts and balls-ups such that de-wetting of the surface of substrate 10 occurs.

In one embodiment, the anneal can be performed at a temperature from 150° C. to 700° C. Other anneal temperatures may also be used as long as the selected anneal temperature converts the continuous metallic layer 12 into a plurality of metallic islands 12P. The anneal is also performed in an inert ambient that does not adversely affect the exposed portions of the substrate 10 that are not protected by a metallic island 12P. In one example, the anneal is performed in helium, argon, nitrogen and/or neon. The anneal that is employed is typically a rapid thermal anneal that is performed for a time period from 1 second to 60 seconds. Other anneals and annealing times can also be used as long as the other anneal and annealing times that are selected are capable of forming metallic islands 12P from the continuous metallic layer 12.

The shape of each metallic island 12P that is formed may vary depending on the thickness of the original metallic layer 12 and the conditions used during the anneal. In one embodiment, and as is illustrated, each metallic island 12P has a semispherical (i.e., domed) shape. The pitch, i.e., distance from one point of a metallic island 12P to the same point on a nearest neighboring metallic island 12P, can be from 100 nm to 5 μm. Other pitches are possible as long as openings 14 are present between the metallic islands 12P. The density, i.e., population, of metallic islands 12P that are present on the surface of the substrate 10 can be from 10¹⁰/m² to 10¹⁴/m². Other densities are possible also long as openings 14 are present between the metallic islands 12P. The pitch and density of the metallic islands 12P may be controlled by the thickness of the original metallic layer 12 and the conditions used during the anneal.

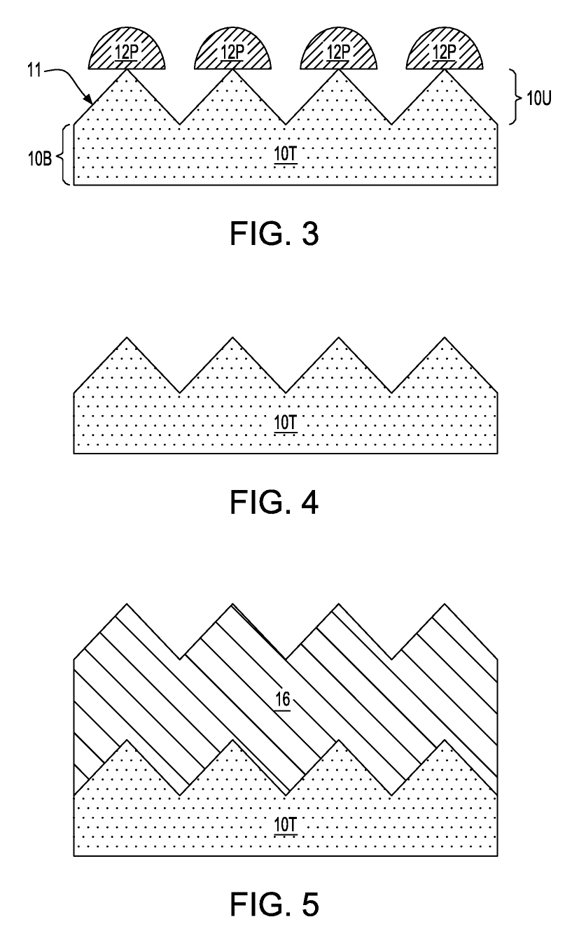

Referring now to FIG. 3, there is illustrated the exemplary semiconductor structure of FIG. 2 after etching the substrate 10 utilizing each metallic island 12P as an etch mask. The etching provides a textured substrate 10T: textured substrate 10T may also be referred to a substrate having a textured surface. The textured substrate 10T includes an upper portion 10U and a lower portion 10B. The upper portion 10U of the textured substrate 10T has a surface roughness that is greater than a surface roughness of the non-textured substrate 10. The surface roughness of the textured substrate 10T can be in a range from 100 nm root mean square to 100 μm root mean square as measured utilizing the same technique as mentioned above for the surface roughness of the non-textured substrate 10. The lower portion 10B of the textured substrate 10T is not textured and functions as a base of the upper portion 10A of the textured substrate 10T.

In some embodiments and as shown, the upper portion 10U of the textured substrate 10T is composed of a plurality of pyramids. Each pyramid includes a pyramidal base that is located on the lower portion 10B of the textured substrate 10T and a pyramidal tip that extends upward from the pyramidal base of each pyramid. Although the present drawing illustrates pyramids having equal heights and widths, in reality the height and/or width of each pyramid may vary. In other embodiments, the upper portion 10U of the textured substrate 10T is composed of a plurality of cones that extend upwards from the lower portion 10B.

The etching that can be employed to provide the textured substrate 10T includes any etch that is selective in removing a portion of the substrate 10 without substantially removing the metallic islands 12P. In one embodiment, the etch that is employed is a reactive ion etch. In some embodiments, and as is shown, the etch employed in the present application undercuts each metallic island 12P.

Referring now to FIG. 4, there is illustrated the exemplary semiconductor structure of FIG. 3 after removing each metallic island 12P from the textured substrate 10T. The removal of the metallic islands 12P may be performed utilizing any material removal process that is selective in removing the metallic islands 12P relative to the textured substrate 10T. In one example, the metallic islands 12P may be removed utilizing an etching process. In another example, the metallic islands 12P can be removed utilizing a planarization process such as, for example, chemical mechanical polishing. The textured substrate 10T remains and can be used as a substrate for forming an all solid-state thin-film battery.

Referring now to FIG. 5, there is illustrated the exemplary semiconductor structure of FIG. 4 after forming an all solid-state battery stack structure 16 on the upper portion 10U of the textured substrate 10T. The all solid-state battery stack structure 16 can be formed utilizing techniques well known to those skilled in the art. For example, the all solid-state battery stack structure 16 can be formed utilizing various deposition processes and a lift-off process can be used to pattern the deposited material layers of the all solid-state battery stack structure 16. Also, the all solid-state battery stack structure 16 includes conventional materials that are also well known to those skilled in the art.

As is shown in FIG. 5, the all solid-state battery stack structure 16 has a bottommost surface that follows the contour of the textured surface of the textured substrate 10T. The topmost surface of the lithium-based battery stack structure 16 may or may not be planar.

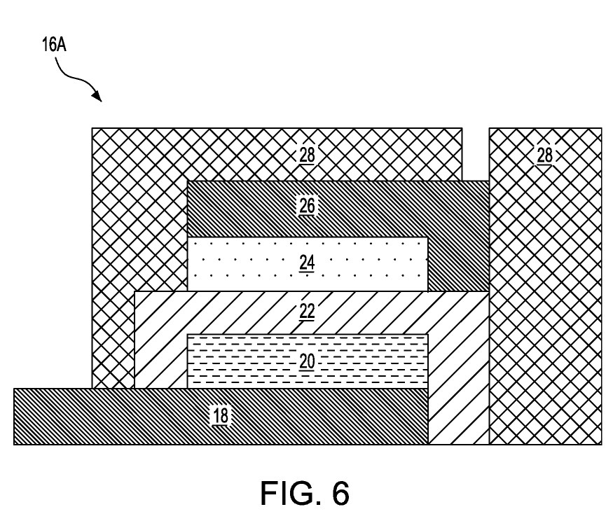

Referring now to FIG. 6, there is illustrated an exemplary lithium-based battery stack structure 16A that can be employed as the all solid-state battery stack structure 16 of FIG. 5. Although a lithium-based battery stack structure 16A is exemplified herein as the all solid-state battery stack structure 16, other types of all solid-state battery stack structures can be formed over the textured substrate 10T.

The lithium-based battery stack structure 16A of FIG. 6 includes a bottom electrode 18, a cathode 20 located on at least a portion of the bottom electrode 18, a solid-state electrolyte 22 located on and surrounding the cathode 20, an anode 24 located on at least a portion of the solid-state electrolyte 22, and a top electrode 26 located on at least the anode 24. The lithium-based battery stack structure 16A further includes a protection layer 28. At least elements 18, 20, 22, 24 are present in other types of all solid-state battery stack structures.

The bottom electrode 18 of the lithium-based battery stack structure 16A may include any metallic electrode material such as, for example, titanium (Ti), platinum (Pt), nickel (Ni), aluminum (Al), or titanium nitride (TiN). In one example, the bottom electrode 18 includes a stack of, from bottom to top, titanium (Ti), platinum (Pt) and titanium (Ti).

The cathode 20 of the lithium-based battery stack structure 16A may include a lithiated material such as, for example, a lithium-based mixed oxide. Examples of lithium-based mixed oxides that may be employed as the cathode 20 of the lithium-based battery stack structure 16A include, but are not limited to, lithium cobalt oxide (LiCoO₂), lithium nickel oxide (LiNiO₂), lithium manganese oxide (LiMn₂O₄), lithium vanadium pentoxide (LiV₂O₅) or lithium iron phosphate (LiFePO₄).

The solid-state electrolyte 22 of the lithium-based battery stack structure 16A includes a material that enables the conduction of lithium ions. Such materials may be electrically insulating or ionic conducting. Examples of materials that can be employed as the solid-state electrolyte 22 of the lithium-based battery stack structure 16A include, but are not limited to, lithium phosphorus oxynitride (LiPON) or lithium phosphosilicate oxynitride (LiSiPON).

The anode 24 of the lithium-based battery stack structure 16A includes any material that is a lithium ion generator or lithium intercalation active material. Examples of materials that may be used as anode 24 include, but are not limited to, lithium metal, a lithium-base alloy such as, for example, LiₓSi, or a lithium-based mixed oxide such as, for example, lithium titanium oxide (Li₂TiO₃).

The top electrode 26 of the lithium-based battery stack structure 16 may include any metallic electrode material such as, for example, titanium (Ti), platinum (Pt), nickel (Ni), copper (Cu) or titanium nitride (TiN). In one example, the top electrode 26 includes a stack of, from bottom to top, nickel (Ni) and copper (Cu). In one embodiment, the metallic electrode material that provides the top electrode 26 may be the same as the metallic electrode material that provides the bottom electrode 18. In another embodiment, the metallic electrode material that provides the top electrode 26 may be different from the metallic electrode material that provides the bottom electrode 18.

The protection layer 28 includes any air and/or moisture impermeable material or a multi-layer stack of the materials. Examples of air and/or moisture impermeable materials that can be used as the protection layer 28 include, but are not limited to, parylene, a fluoropolymer, silicon nitride, and/or silicon dioxide.

As stated above, the present application provides a three-dimensional (3D) thin-film battery device that has improved capacity and reduced specific resistance, without increased lateral battery size. These improved properties are a result of providing the textured substrate 10T.

The textured substrate 10T can increase the interfacial area between a solid-state electrolyte and the electrode material, which may in turn, facilitate metal ion. e.g., lithium ion, transfer to the electrode material. Moreover and in some embodiments, the textured substrate 10T may be used to provide a 3D thin-film battery device that has decreased metal ion, e.g., lithium ion, diffusion and electron path length with a cathode as compared to a 3D thin-film battery device that contains a non-textured (i.e., planar) substrate. Furthermore and due to the increased surface roughness of the textured substrate 10T, improved adhesion can be observed between the substrate and the various components of the all solid-state battery stack structure 16, e.g., the lithium-based battery stack structure 16A.

While the present application has been particularly shown and described with respect to preferred embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. A method of forming a three-dimensional (3D) thin-film battery, the method comprising:
forming a continuous metallic layer on a surface of a substrate;
annealing the continuous metallic layer to convert the continuous metallic layer into a plurality of metallic islands;
etching the substrate utilizing each metallic island as an etch mask to provide the substrate with a textured surface;
removing each metallic island; and
forming an all-solid-state battery stack structure on the textured surface of the substrate.

2. The method of claim 1, wherein the continuous metallic layer comprises a metal or metal alloy having a melting point below 700° C.

3. The method of claim 2, wherein the continuous metallic layer includes tin, indium, gallium or alloys thereof.

4. The method of claim 3, wherein the continuous metallic layer consists of tin.

5. The method of claim 1, wherein the annealing is performed at a temperature from 150° C. to 700° C.

6. The method of claim 1, wherein the etching comprises a reactive ion etch.

7. The method of claim 1, wherein the surface of the substrate has a first surface roughness and the textured surface of the substrate has a second surface roughness that is greater than the first surface roughness.

8. The method of claim 1, wherein the substrate having the textured surface comprises an upper portion composed of a plurality of pyramids located on a lower portion.

9. The method of claim 1, wherein the forming the all solid-state lithium-based battery stack comprises forming a bottom electrode, a cathode, a solid-state electrolyte, an anode, and a top electrode.

10. The method of claim 9, wherein the all solid-state battery stack structure is a lithium-based battery stack structure, wherein the cathode comprises a lithium-based mixed oxide, the solid-state electrolyte comprises a material that enables the conduction of lithium ions, and the anode comprises a lithium ion generator or lithium intercalation active material.
